(19) United States
(12) Patent Application Publication
(10) Pub. No.: US 2008/0024717 A1
(43) Pub. Date: Jan. 31, 2008

(54) Contact lens used in orthokeratology

(76) Inventor: Stanton Kim, Gilroy, CA (US)

Correspondence Address: DR. STANTON KIM, 10760 GREEN VALLEY DR., GILROY, CA, 95020, US

(21) Appl. No.: 11/494,938

(22) Filed: Jul. 28, 2006

(51) Int. Cl. G02C 7/04

(52) U.S. Cl. 351/160 R

(57) ABSTRACT

A contact lens for vision correction, comprising a central zone, an alignment zone located concentrically around the central zone, and a bearing zone that is coupled to both the central zone and the alignment zone. The bearing area is configured to directly contact a cornea and prevent both the central zone and alignment zone from directly contacting the cornea

### FIELD OF THE INVENTION

The present invention relates generally to a contact lens configured to improve the vision characteristics of a human eye, and more particularly, to a semi-rigid gas permeable contact lens and a corresponding orthokeratology treatment method for improving visual acuity.

### BACKGROUND

A large portion of the population experience difficulty with their vision due to a number of possible conditions. The majority of these vision problems result from a condition known as myopia, or nearsightedness. Myopia is a common condition where an eye cannot focus on far objects because the cornea of the eye is curved too steeply to provide adequate focusing at the retina of the eye. Alternatively, the eye may be afflicted with a condition know as hyperopia, or farsightedness. With hyperopia, the eye cannot focus on near objects because the cornea of the eye is curved too flatly to provide adequate focusing at the retina of the eye.

Contact lenses can be made to correct most visual conditions correctable by regular eyeglasses. Moreover, contact lenses are not readily visible and provide the user with a wider field of vision than do eyeglasses. The first contact lenses were of the “hard” variety, that were lathe cut and polished, or were molded of a relatively rigid material, and formed by heat and pressure to the shape of a wearer's or user's eye. A recent innovation has been the “soft” contact lens constructed of flexible, liquid absorbent, and gas permeable material. Generally, soft contact lenses are inserted into the eye to improve vision, however, when the soft contact lens is removed, there are no permanent or temporary vision improvements.

Another approach to improving vision is to alter the shape of the cornea by wearing contact lenses designed to continually exert pressure on selected locations of the cornea. The contact lenses gradually force or mold the cornea into a desired corneal curvature. This method of treatment is commonly referred to as orthokeratology. The success of any treatment by orthokeratology is dependent upon the shape and structure of the corneal contact lens. Referring to FIG. 1A, an orthokeratology approach to improving myopia uses a contact lens 1 having a radius of curvature which is generally greater than the radius of curvature of the wearer's cornea 2. When the lens 1 is worn on the cornea, the capillary action of the lens on the eye provides an inward force or pressure 3 to the center of the cornea in conjunction with an outward force or pressure 4 to the periphery of the cornea. The lens flattens the cornea, improving the wearer's vision. Referring to FIG. 1B, an orthokeratology approach to improving hydropia uses a contact lens 1 having a radius of curvature which is generally smaller than the radius of curvature of the wearer's cornea 2. When the lens 1 is worn on the cornea, the capillary action of the lens on the eye provides an outward force or pressure 3 to the center of the cornea in conjunction with an inward force or pressure 4 to the periphery of the cornea. The lens steepens the cornea, improving the wearer's vision.

From approximately 1950 to 1970, research in Orthokeratology included PMMA (Polymethyl Methacrylate) and then with RGP (rigid gas permeable) lenses. RGP lenses have been found to be effective in improving vision, however many users found the lenses uncomfortable or difficult to get used to. Soft contact lenses are much more comfortable from the user perspective however, soft contact lenses are not rigid enough to reshape or mold the corneal surface of a human eye. Recently, contact lenses made using a Silicon Hydrogel material were introduced and this type of contact lens has been FDA approved for continuous wear up to 30 days. Also available are “Hybrid Lenses” having an RGP center and having a soft contact lens material “skirt” in the periphery of contact lens.

In U.S. Pat. No. 4,952,045, a corneal contact lens includes a central zone, a tear zone, and a transition zone located concentrically between the central zone and tear zone to provide a more gradual change in the radius of curvature. Although there is an improvement, the wearing comfort of the lens is still not as comfortable as a soft contact lens. Thus, what is needed is a contact lens and corresponding treatment method that corrects myopia and hyperopia, and also reduces discomfort to the lens wearer.

### SUMMARY OF THE INVENTION

An orthokeratological contact lens comprising a central zone, an alignment zone located concentrically around the central zone; and a bearing zone. The bearing zone is configured to contact a cornea and prevent both the central zone and alignment zone from directly contacting the cornea.

### BRIEF DESCRIPTION OF THE DRAWINGS

FIG. 1A is a cross-sectional view of a prior art orthokeratology contact lens.

FIG. 1B is a cross-sectional view of another prior art orthokeratology contact lens.

FIG. 2 is a frontal view of an exemplary embodiment of an orthokeratology contact lens.

FIG. 3 is an exploded cross-sectional view of an exemplary orthokeratology contact lens.

FIG. 4A is a frontal view of a first alternative exemplary embodiment of an orthokeratology contact lens.

FIG. 4B is a frontal view of a second alternative exemplary embodiment of an orthokeratology contact lens.

FIG. 4C is a frontal view of a third alternative exemplary embodiment of an orthokeratology contact lens.

FIG. 4D is a frontal view of a fourth alternative exemplary embodiment of an orthokeratology contact lens.

FIG. 5A is a cross-sectional view of an exemplary embodiment of an orthokeratology contact lens.

FIG. 5B is a cross-sectional view of another exemplary embodiment of an orthokeratology contact lens.

FIG. 6 is a cross-sectional view of an alternative exemplary embodiment of an orthokeratology contact lens, positioned on a wearer's corneal surface.

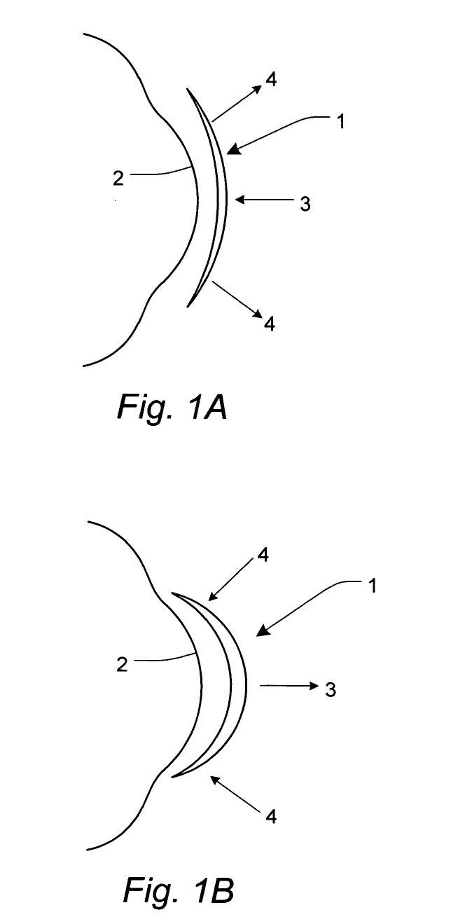

### DETAILED DESCRIPTION

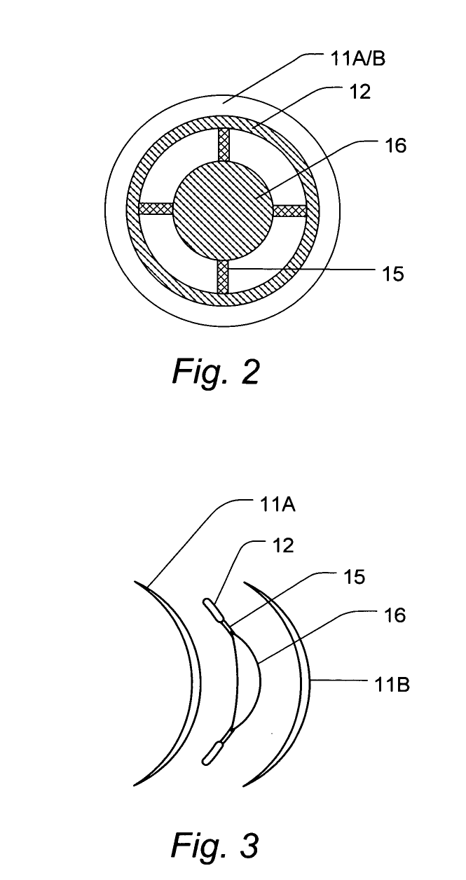

Referring to FIG. 2, an exemplary contact lens includes a circular central zone 16 configured to provide a primary corrective force to a wearer's cornea, and an alignment ring or alignment zone 12 which may provide a secondary corrective force to the wearer's corneal area. An optional stabilizing bridge 15, coupling the central zone 16 to the alignment zone 12 may be included. Referring to FIG. 3, an exploded view of the exemplary contact lens includes a base zone or bearing zone 11A which couples the central zone 16 to the alignment zone 12. A cover zone 11B may also couple the central zone to the alignment zone and is configured to provide a smooth or improved eyelid contact surface.

The central zone 16 is configured to provide a primary corrective force to increase the radius of curvature (flatten) or to decrease the radius of curvature (elongate) of a wearer's cornea. The central zone 16 applies an appropriate force to a region substantially centered at the apical center of a wearer's cornea for the correction of myopia, or applies an appropriate force to a region circumscribing an apical center of a wearer's cornea for the correction of hyperopia. The central zone 16 has a radius of curvature defined by the optical characteristics of the wearer's vision to correct the myopic or hydropic condition. The central zone 16 may range from 3 mm to 13 mm in diameter and the radius of curvature for the central zone 16 may range from 6 mm to 14 mm. The central zone 16 thickness may range from 0.1 mm to 1 mm. The central zone 16 is generally made from a hard or semi hard material that may be gas permeable. However, the central zone 16 may also be made from a soft or semi soft material having a greater density or increased stiffness in comparison to the bearing zone 11A material. The central zone 16 may or may not necessarily provide optical lens characteristics to the contact lens.

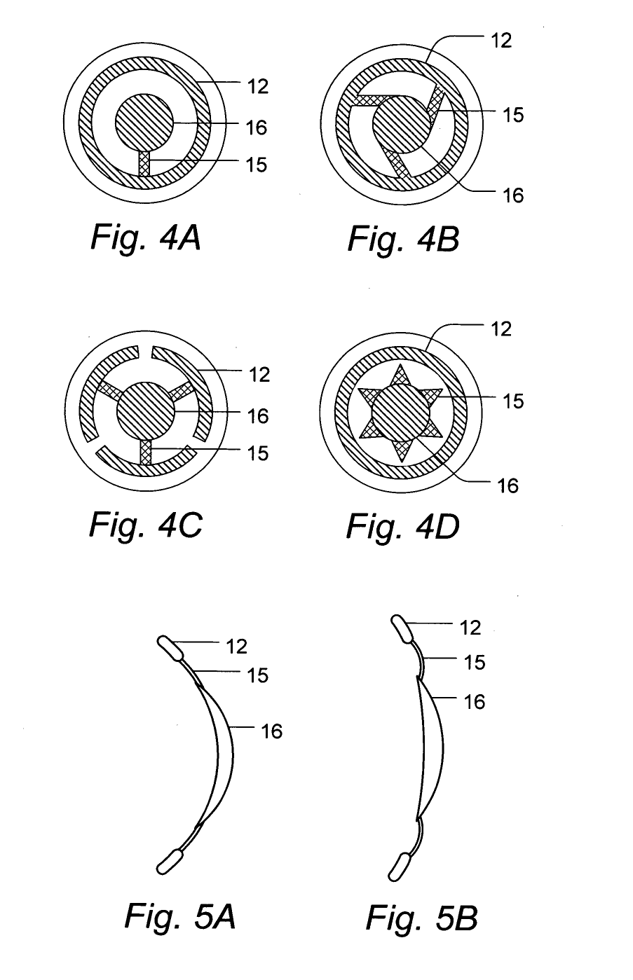

The alignment zone 12 is configured to produce a centering force to maintain the central zone 16 at the approximate apical center of the wearer's cornea. The alignment zone 12 has a radius of curvature also defined by the optical characteristics of the wearer's cornea. The alignment zone 12 may have a radius of curvature to match a wearer's cornea, to compensate for a myopic or hydropic condition, and/or apply a secondary force to a peripheral region of a wearer's cornea. The outer diameter of the alignment zone 12 may range from 10 mm to 14 mm and the radius of curvature for the alignment zone 12 may range from 6 mm to 14 mm. The alignment zone 12 may be continuous, referring to FIGS. 4A-B and 4D, or non-continuous as shown in FIG. 4C. The thickness the alignment zone 12 is generally less than the thickness of the central zone 16. The alignment zone 12 may be made from the same material as the central zone 16, or from a different material including hard, semi-hard, or soft contact lens materials such as hydrogel or silicone polymers.

The stabilizing bridge 15 may be used to further control the amount of flexure between the central zone 16 and the alignment zone 12. Referring to FIGS. 4A-D, a stabilizing bridge 15 may comprise a single member (FIG. 4A) or a plurality of members (as shown in FIGS. 2, 3, and 4B-C) coupling the central zone 16 and the alignment zone 12. In the alternate embodiments shown in FIGS. 4A-C, acentral zone 16 is coupled to stabilizing bridge(s) 15, and each stabilizing bridge 15 may be directly coupled to the alignment zone 12. Referring to FIG. 4D, in an alternative embodiment, stabilizing bridge(s) 15 are coupled to an alignment zone 12 via the base zone or bearing zone 11A (see FIG. 3) and the stabilizing bridge(s) 15 are not directly coupled to the alignment zone 12. In other embodiments, stabilizing bridge(s) 15 may have no direct contact or coupling with either an alignment zone 12 or a central zone 16, and may be coupled to the alignment zone 12 and the central zone 16 via the base zone or bearing zone 11A.

Referring to FIGS. 4A-D and 5A-B, with respect to the radius of curvature of a wearer's cornea, the stabilizing bridge(s) 15 generally provide an overall contact lens radius of curvature similar to or approximating the radius of curvature of the central zone 16 and/or the alignment zone 12. However, the stabilizing bridge 15 member may have a variety of shapes and be coupled to the central zone 16 and the alignment zone 12 at a variety of angles.

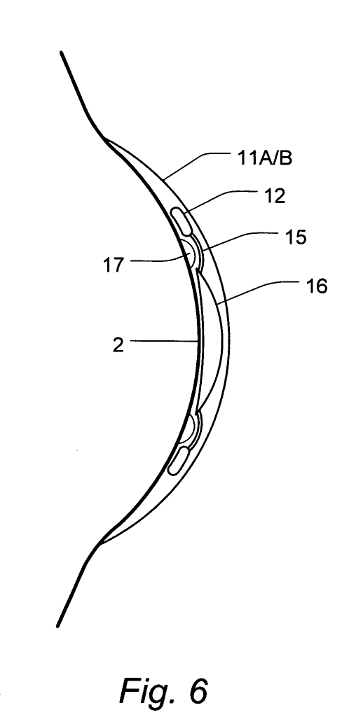

Referring to FIGS. 3 and 6, a base or bearing zone 11A, directly contacting the wearer's cornea 2, is coupled to both the central zone 16 and the alignment zone 12. The bearing zone 11A may be coupled to both the central zone 16 and the alignment zone 12 by fusing or heating the materials together, applying adhesives, or by sandwiching the central zone 16 and the alignment zone 12 between the base zone 11A and a cover zone 11B. A cover 11B may be coupled to the bearing zone, configured so that the cover and bearing zone sandwich or capture the central zone and alignment zone.

The bearing zone 11A is configured to directly contact a cornea and also configured to prevent both the central zone and alignment zone 12 from directly contacting the cornea. The bearing zone 11A is also configured to provide a flexible interface between the central zone 16 and the alignment zone 12. The bearing zone 11A is made from a material generally having greater flexibility characteristic than the material of the central zone 16, for example, hydrogel, silicone polymers, and other soft or semi-soft materials having flexible properties.

The bearing zone 11A is configured to provide a flexible or pivoting area to allow the portion of the lens between the central zone 16 and the alignment zone 12 to flex or lift. The flex or lift provides at least one of the following properties or characteristics to the lens: 1) the lens more closely conforms to the shape of the cornea as the cornea changes shape over time, 2) a transition space or tear zone between the central zone 16 and the alignment zone 12 may be developed, 3) the alignment zone 12 is allowed to flex more easily, allowing the alignment zone 12 to flex and change diameter, 4) improved capillary action holding the lens to the wearer's cornea, 5) more room under the lens is provided for the cornea, allowing the cornea to change shape in response to the primary force of the central zone, 6) improved control or variability of a secondary force to a peripheral region of a wearer's cornea, 7) increased variability in the shape of the lens allowing the wearer to use the same lens over a longer period of time, or 8) provide a comfortable surface allowing a longer wearing time.

An optional tear zone 17 may be incorporated into the contact lens to further control the flexure of the bearing zone between the central zone 16 and the alignment zone 12, facilitate the redistribution of mid-peripheral corneal tissue, facilitate stabilization of the lens on the corneal surface, or to facilitate tear circulation over the corneal surface. The tear zone radius of curvature is smaller than the central zone radius of curvature and is positioned between the central zone 16 and alignment zone 12.

In soft silicone-hydrogels, the monomer ratios may be adjusted to produce water contents in the 20% to 50% range. These lenses are very similar to standard hydrogel lenses, with the added advantage of increased oxygen permeability. The oxygen permeability is controlled principally by the amount of silicone monomer in the formulation. Such lenses may be surface treated to restore optimum surface properties. Currently all silicone-hydrogel lenses are molded, however, soft and rigid silicone-hydrogel lenses may be lathe cut.

Rigid or semi-rigid silicone-hydrogel polymers may be made using a water content range from 0 to 60% by varying the monomer ratios. At low water contents, the polymers are more rigid. There are two types of rigid silicone-hydrogel materials. In one type, the water content and expansion is constrained by decreasing the ratio of hydrophilic monomers and increasing crosslink density. The polymer may not absorb water into the interior of the matrix, but the surface may be able to exhibit hydrate properties similar to a hydrogel lens. In a second type of silicone-hydrogel polymer, a reactive hydrolyzable monomer is included in the formulation. When the lens is placed in water, the reactive monomer hydrolyzes producing a hydrophilic surface like a hydrogel lens. The reaction cannot proceed into the interior since expansion is constrained by cross-linking. This type has the novel property of regenerating the hydrophilic surface if the lens is damaged or the lens is repolished. There are also hybrid materials that contain both hydrophilic and reactive monomers.

The present invention is not to be limited in scope by the specific embodiments described herein. For example, a variety of materials and techniques may be used to produce the described lenses. Various modifications of the invention in addition to those described herein will become apparent to those skilled in the art from the foregoing description and accompanying figures, and such modifications are intended to fall within the scope of the claims. For example, a central zone 16, alignment zone 12, or stabilizing bridge 15 may be made of various materials, such as hard, semi-hard, or soft contact lens materials including: hydrogel, soft silicone-hydrogels, silicone polymers, silicone-hydrogel polymers, surgical stainless steel, various metals including those having a structural memory, a plastic or metal mesh, or silicon.

I claim:

1. A corneal contact lens for vision correction, the corneal contact lens comprising:
a central zone having a central zone radius of curvature, a central zone lateral thickness, and a central zone diameter;
an alignment zone located concentrically around the central zone; and
a bearing zone coupled to the central zone and coupled to the alignment zone, the bearing area being configured to directly contact a cornea and prevent both the central zone and alignment zone from directly contacting the cornea.

2. The corneal contact lens of claim 1 wherein the central zone is configured to apply a central compressive force in a region substantially centered at an apical center of a cornea during vision correction.

3. The corneal contact lens of claim 1 wherein the central zone has a radius of curvature greater than a measured radius of curvature of a central portion of a cornea.

4. The corneal contact lens of claim 1 wherein the alignment zone is configured to produce a centering force to maintain the central zone substantially at the apical center of a cornea.

5. The corneal contact lens of claim 1 wherein the alignment zone lateral thickness that is less than the lateral thickness of the central zone.

6. The corneal contact lens of claim 1 wherein the bearing zone is made from a material that is more flexible than the material of the central zone.

7. The corneal contact lens of claim 1 further comprising a stabilizing bridge coupled to the central zone and coupled to the alignment zone.

8. The corneal contact lens of claim 8 wherein the stabilizing bridge, the central zone, and the alignment zone are made from the same material.

9. The corneal contact lens of claim 1 wherein the central zone, alignment zone, and stabilizing bridge are made from materials that are less flexible than the bearing zone material.

10. The corneal contact lens device of claim 1, further comprising a cover coupled to the central zone and coupled to the alignment zone.

11. The corneal contact lens device of claim 1, further comprising a cover coupled to the bearing zone, the cover and bearing zone sandwiching or capturing both the central zone and alignment zone.

12. The corneal contact lens of claim 1 wherein the cover is made from a soft material, the soft material having greater flexibility characteristic than the material of the central zone.

13. The corneal contact lens of claim 1, wherein the corneal contact lens is constructed from at least one gas permeable material.

14. The corneal contact lens of to claim 1 wherein said central zone is made from a gas permeable semi-hard or hard material.

15. The corneal contact lens of claim 14 further comprising an alignment zone made from a semi-hard or soft material.

16. The corneal contact lens of claim 1 further comprising a central zone made from hard or semi-hard material and a bearing zone made from a soft polymer.

17. The corneal contact lens of claim 1 further comprising a central zone, alignment zone, or stabilizing bridge made from a metal mesh material.

18. The corneal contact lens device of claim 1, further comprising a tear zone located concentrically around said central zone, the tear zone having a tear zone radius of curvature smaller than said central zone radius of curvature.

19. A contact lens device for vision correction, the contact lens comprising:
a central zone;
an alignment zone located concentrically around the central zone, the alignment zone being configured to maintain the central zone substantially at the apical center of a cornea;
a bearing zone made from soft or semi-soft material, the bearing zone being configured to directly contact a cornea and to prevent both the central zone and alignment zone from each having direct contact with a cornea; and
a cover coupled to the bearing zone, the cover and bearing zone being configured to capture the central zone and the alignment zone.

20. The contact lens of claim 19 further comprising a stabilizing bridge coupled to the central zone and coupled to the alignment zone.

21. The contact lens of claim 20 wherein the stabilizing bridge, the central zone, and the alignment zone are made from the same material.

22. The corneal contact lens of claim 19 which includes a central zone made from hard or semi-hard material and a bearing zone made from a soft polymer.

23. A contact lens for vision correction, the contact lens comprising:
a central zone made from a semi-hard or hard material;
an alignment zone located concentrically around the central zone, the alignment zone being configured to maintain the central zone substantially at the apical center of a cornea;
a bearing zone coupled to the central zone and alignment zone, the bearing zone made from soft or semi-soft material, and the bearing zone being configured to contact a cornea and to prevent both the central zone and alignment zone from each having direct contact with a cornea; and
a stabilizing bridge coupled to the central zone and the alignment zone.

24. The contact lens device of claim 23, further comprising a cover coupled to the central zone and coupled to the alignment zone.

25. The contact lens device of claim 23, further comprising a cover coupled to the bearing zone, the cover and bearing zone sandwiching or capturing both the central zone and alignment zone.

26. The corneal contact lens of claim 23 which includes a central zone made from hard or semi-hard material and a bearing zone made from a soft polymer.
